(19) United States
(12) Patent Application Publication
(10) Pub. No.: US 2003/0012934 A1
(43) Pub. Date: Jan. 16, 2003

(54) Polymer gel composition and optical element using the same

(75) Inventors: Jun Kawahara, Minamiashigara-shi (JP); Hiroaki Tsutsui, Minamiashigara-shi (JP); Masato Mikami, Minamiashigara-shi (JP); Ryojiro Akashi, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/095,481

(22) Filed: Mar. 13, 2002

(30) Foreign Application Priority Data
Jul. 12, 2001 (JP) 2001-345865

(51) Int. Cl. B32B 3/00; B32B 7/00; B32B 9/00; B32B 15/00; B32B 17/06; G02F 1/15

(52) U.S. Cl. 428/209; 428/429; 359/265

(57) ABSTRACT

A polymer gel composition and an optical element using the same are provided. The polymer gel composition has a simple constitution, can be applied for a display element of transmission type, and exhibits large differences in the light-scattering index, light refractive index, and light absorption according to an imposed electric field with stable repeating performance. The polymer gel composition and the optical element using it contain a liquid and a charged polymer gel that exhibits volumetric change depending on the absorption/releasing of the liquid according to an imposed electric field.

### BACKGROUND OF THE INVENTION

1. Field of the Invention

The present invention relates to a polymer gel composition and an optical element employing the polymer gel composition, which may be widely applied for light controlling glass, light controlling element, or display element. More particularly, the present invention relates to a polymer gel composition and an optical element employing the polymer gel composition, which possess a wide variety of characteristics such as reversible color change depending on an imposed electric field, ability of light scattering, controllability of transmitting light or reflecting light in a wide range of spectrum, and displaying of multi-colored tone or pattern.

2. Description of the Related Art

The needs for a color displaying system or a wide screen displaying system is increasing along with the development of highly information-driven society. Various displaying technologies have been developed to materialize the needs including CRT, liquid crystal, EL, LED, or plasma. In addition to these active display systems, development of a passive display system is under intense investigation, which works with low power consumption and gives less sense of discomfort to human eyes. A technology on light reflecting liquid crystal is a major candidate for these passive display systems.

Meanwhile the needs for an inexpensive color displaying system or an inexpensive wide screen displaying system are also eminent. But a promising technology for materializing such needs is not yet established at present, although the electrophoresis or the twist-ball method is known to be a potential candidate. Furthermore, an energized display technology employing a stimulation-responsive polymer gel is known.

The following technologies have been disclosed for the energized display technology employing a polymer gel:

Japanese Published Unexamined Patent Application No. Hei 04-134325 and Japanese Published Unexamined Patent Application No. Hei 05-188354 propose an element that conducts light control and displaying based on the difference of transparency/opaque by changing the light-scattered state deriving from swelling/compression of a polymer gel at energization.

Japanese Published Unexamined Patent Application No. Hei 04-274480 proposes an optical element that utilizes the phenomenon of swelling/compression at energization for a colored polymer gel making covalent bonds with a dyestuff. In the patent, the energization induces swelling/compression of a polymer gel, an increase/decrease in the cross section for light absorption in turn, and finally a change in the optical density.

Japanese Published Unexamined Patent Application No. Hei 09-160081 proposes an optical element coupled with a colored base plate and a colored polymer gel. It discloses a technology for an optical element, in which the optical density may be fluctuated by changing the content of a colored base plate covered with a colored polymer gel. This change is brought about with bending, stretching, swelling, or compression of a colored polymer gel induced by electric stimulation.

Japanese Published Unexamined Patent Application No. Sho 61-149926 proposes an optical element including a composition, in which a polymer gel exhibiting swelling/compression at energization is combined with a colored liquid made from a dispersed pigment and a liquid. In the patent, a colored liquid is made to transfer by a structural change of a polymer gel at energization. At the same time a change in the amount of light absorption for the colored liquid is provoked. The patent presents a technology that utilizes the change.

Japanese Published Unexamined Patent Application No. Hei 07-95172 and Japanese Published Unexamined Patent Application No. Hei 11-236559 disclose a technology, which, by employing a conductive polymer and the like as an electrode, prevents electric decomposition of a liquid in general at energization and inhibits generation of air bubbles arising from the electric decomposition.

However, the technologies disclosed in the above patents for the light controlling element and display element had much to be improved.

For example, Japanese Published Unexamined Patent Application Nos. Hei 04-134325, Hei 05-188354, Hei 04-274480, Hei 09-160081, and Sho 61-149926 have disclosed a similar element. When energization was conducted, the solvent employed for keeping the structure of a polymer gel was decomposed owing to the air bubbles arising from the electric decomposition of the solvent. This led to the deterioration of the displaying quality and the light controlling characteristics at energization.

Japanese Published Examined Patent Application No. Hei 07-95172 has a problem that sufficient contrast for the display, variable margin for the refractive index, and light absorption are not achieved due to the inherent color of a conductive polymer that is installed on an electrode. The employed conductive polymer also exhibits a defect, when used for an element, of insufficient durability at energization. Furthermore, it is impossible to apply the element for a display element of transmitting type as the conductive polymer has inherent coloration and the constitution of the element is also specific.

Japanese Published Unexamined Patent Application No. Hei 11-236559 employs a similar conductive polymer as in Japanese Published Examined Patent Application No. Hei 07-95172, and is plagued with insufficient contrast for the display and variable margin for the refractive index and light absorption. As a result, it has a defect of inferior stability at energization. Further, as the constitution of the electrode is very complicated, the production cost of the element is estimated to be very high.

Concerning the abovementioned technology for the light controlling element and display element based on energization, a general technique is to induce a volumetric change of a polymer gel according to a change in the ionic concentration of the employed solvent (or swelling liquid). But it is associated with a problem that the displaying quality and the light controlling characteristics are deteriorated at repeated energization due to the air bubbles produced by electric decomposition. It is also impossible to apply the element for a display element of transmitting type. Further, as the constitution of the electrode is very complicated, the production cost of the element is estimated to be very high to result in a call for improvement in this area at present.

### SUMMARY OF THE INVENTION

The present invention has been made in view of the above circumstances to solve the abovementioned problems and provides a polymer gel composition that may exhibit large differences in the light scattering index, light refractive index, and light absorption according to an imposed electric field. The polymer gel composition may have a stable repeating performance and a simple constitution, and can be applied for a display element of transmitting type. The present invention also provides an optical element that employs the above polymer gel composition.

The polymer gel composition contains a liquid and a charged polymer gel composition that changes volume by absorbing or releasing the liquid depending on an imposed electric field.

The liquid may be an insulating liquid.

The liquid may possess a volumetric resistivity 10³ Ω or higher.

The charged polymer gel may be an ionic polymer gel.

The charged polymer gel may be an ionic polymer gel containing a charging agent.

The charged polymer gel may be a non-ionic polymer gel containing a charging agent.

The charged polymer gel may contain a light controlling material.

The agent may be a light controlling material.

The charged polymer gel may have a spherical form.

The optical element has the above-described polymer gel composition.

The optical element may have an electric field applying unit that applies an electric field to the polymer gel composition;

The optical element may have an electrode that applies an electric field to the polymer gel composition, and the charged polymer gel may be fixed on the electrode.

### BRIEF DESCRIPTION OF THE DRAWING

Preferred embodiments of the present invention will be described in detail based on the followings, wherein:

FIG. 1 is a schematic diagram illustrating a preferred embodiment for an optical element according to the present invention; and

FIG. 2 is a schematic diagram illustrating another preferred embodiment for an optical element according to the present invention.

### DETAILED DESCRIPTION OF THE PREFERRED EMBODIMENTS

A detailed description of the present invention is given hereinafter with particularity.

The polymer gel composition according to the present invention is characterized by a liquid and a charged polymer gel wherein the latter exhibits a volumetric change based on the absorption/release of the above liquid according to imposed electric field. The polymer gel composition according to the present invention includes a liquid and a charged polymer gel, and facilitates a large reversible volumetric change depending on an imposed electric field. It is also possible to change its optical characters extensively based on a change in the light absorption cross section at the time of swelling/compression even when the charged polymer gel contains a light controlling material such as pigment or dyestuff in dispersed form. Thus the polymer gel according to the present invention is satisfactorily applied for an optical element such as light controlling element or display element. Meanwhile, the above volumetric change is induced presumably by the interaction of the charged polymer gel and the electric field.

The polymer gel according to the present invention includes a liquid and a charged polymer gel. With this constitution it is easy to prevent the generation of air bubbles due to the electric decomposition of the liquid arising from an electrode reaction. Thus the deterioration in the light controlling characteristics at repeated energization is avoided, leading to the superior stability for repeated use. It is also possible to change the index of light scattering or light refraction, and the amount of light absorption to a large extent according to imposed electric field. Furthermore, it has a simple constitution, and can be applied for various optical elements including color display element or light controlling element of transmitting type or laminated type.

A description of the charged polymer gel is given hereinafter.

The embodiments for the charged polymer gel may be selected from an ionic polymer gel, an ionic polymer gel containing a charging agent, and a non-ionic polymer gel containing a charging agent. Preferred embodiments of each gel species are listed below. Note that a description such as (meth)acrylate denotes both acrylate and methacrylate.

<1>Ionic Polymer Gel

Examples of the ionic polymer gel include cross-linked products of poly-(meth)acrylic acid and their salts; copolymers of (meth)acrylic acid with (meth)acrylamide, hydroxyethyl-(meth)acrylate, (meth)acryl acid alkyl esters and their cross-linked products and their salts; cross-linked products of poly-maleic acid and their salts; copolymers of maleic acid with (meth)acrylamide, hydroxyethyl-(meth)acrylate, (meth)acryl acid alkyl esters and their cross-linked products and their salts; copolymers of cross-linked products of poly-vinylsulfonic acid with copolymers with vinylsulfonic acid, (meth)acrylamide, hydroxyethyl-(meth)acrylate, and (meth)acrylic acid alkyl ester and their cross-linked products; cross-linked products of poly-vinylsulfonic acid and their salts; copolymers of vinylsulfonic acid with (meth)acrylamide, hydroxyethyl-(meth)acrylate, (meth)acryl acid alkyl esters and their cross-linked products and their salts; cross-linked products of poly-vinylbenzene sulfonic acid and their salts; copolymers of vinylbenzene sulfonic acid with (meth)acrylamide, hydroxyethyl-(meth)acrylate, (meth)acryl acid alkyl esters and their crosslinked products and their salts; cross-linked products of poly-acrylamidealkylsulfonic acid and their salts; copolymers of acrylamide-alkylsulfonic acid with (meth)acrylamide, hydroxyethyl-(meth)acrylate, (meth)acryl acid alkyl esters and their cross-linked products and their salts; cross-linked products of poly-dimethylaminopropyl-(meth)acrylamide and their hydrochloric acid salts; copolymers of dimethylaminopropyl(meth)acrylamide with (meth)acrylamide, hydroxyethyl-(meth)acrylate, (meth)acryl acid alkyl esters and their cross-linked products and their quaternary salts; cross-linked products for a complex of polydimethylaminopropyl-(meth)acrylamide with poly-vinylalcohol, and their quaternary salts; cross-linked products for a complex of polyvinyl alcohol with poly-(meth)acrylic acid, and their quaternary salts; cross-linked products of carboxylalkylcellulose and their salts; and partially hydrolyzed cross-linked products of poly-(meth)acrylonitrile and their salts.

These ionic polymer gels may be prepared with addition of cross-linking agent, irradiation of electron beam or gamma ray on a polymer gel, heat processing, or addition of peroxide, leading to the three-dimensional cross-linking.

<2>Ionic Polymer Gel Containing Charging Agent

Examples of the ionic polymer gel that constitutes the ionic polymer gel containing a charging agent are similar to the ionic polymer gel listed in the above (1).

Concerning the examples of charging agent contained in the ionic polymer gel, there are various amphipathic molecules and polymers, Nigrosine-based compounds, alkoxylated amines, quaternary ammonium salts, alkylamides, elemental phosphor and wolfram and their compounds, pigments based on molybdenum chelates, hydrophobic silica, borons, halogenated compounds, metal chelates of monoazo-dyestuff, salicylic acid, alkyl-salicylic acid, dialkyl-salicylic acid, metal chelates of naphthoic acid, chlorinated polyolefins, chlorinated polyesters, polyesters having excess acid radical, sulfonyl amines of copper-phthalocyanine, oil-black, metal salts of naphthenic acid, metal salts of fatty acids, and metal soaps of resin acid.

The content of charging agent contained in the ionic polymer gel is preferably between 2 weight % and 70 weight %.

The charging agent may also work as a light controlling material, which is described hereinafter. The content of light controlling material contained in the ionic polymer gel is preferably between 2 and 70 weight %, and most preferably between 5 and 50 weight %. Furthermore, another charging agent different from the above light controlling material may be included in the ionic polymer gel in order to improve response of the ionic polymer gel to imposed electric field. In this case, the content of the charging agent different from the light controlling material contained in the ionic polymer gel is preferably between 2 and 70 weight %.

<3>Non-Ionic Polymer Gel Containing Charging Agent

The non-ionic polymer gel is defined as a polymer gel that does not contain dissociated ionic radicals in the polymer chain. In more detail, preferred examples of them include cross-linked homo-polymers comprising larger than one species selected from the monomer group listed hereinafter, or cross-linked copolymers comprising more than two species selected from the monomer group listed below.

Monomer group:

(Meth)acrylonitrile, alkyl esters of (meth)acrylic acid, dialkylaminoalkyl esters of (meth)acrylic acid, (meth)acrylamide, ethylene, propylene, butadiene, isoprene, isobutylene, N-dialkyl-substituted (meth)acrylamides, vinylpyridine, vinylamines, allylamine, styrene, vinylcarbazole, vinylpyrrolidone, styrene derivatives, ethylene glycol (meth)acrylate, glyceryl (meth)acrylate, polyethylene glycol mono(meth)acrylate, vinyl chloride, vinylidene chloride, ethylene glycol di(meth)acrylate, methylene-bisacrylamide, diethylene glycol di(meth)acrylate, butanediol di(meth)acrylate, and hexane diol di(meth)acrylate.

In addition to the above, there are cross-linked products of various polymers including polyesters, polyvinylacetal derivatives, polyurethanes, polyureas, polyethers, polyamides, and polycarbonates. They are favorably employed for the same purpose.

Production of non-ionic polymer gel is feasible using addition of cross-linking agent to raw polymers, irradiation of polymers with electron beam or gamma ray, heat processing, or addition of peroxide for the three-dimensional cross-linking.

Examples of the charging agent contained in the non-ionic polymer gel are similar to the substances exemplified for the ionic polymer gel containing charging agent in the above <2>.

The content of charging agent contained in the non-ionic polymer gel is preferably between 2 and 70 weight %.

The charging agent may also work as a light controlling material. The content of light controlling material contained in the non-ionic polymer gel is preferably between 2 and 70 weight %, and most preferably between 5 and 50 weight %. Furthermore, another charging agent different from the above light controlling material may be included in the non-ionic polymer gel in order to improve response of the non-ionic polymer gel to imposed electric field. In this case, the content of the charging agent different from the light controlling material contained in the non-ionic polymer gel is preferably between 2 and 70 weight %.

When the polymer gel composition according to the present invention is employed for an optical element or a display element, it is favorable to add a light controlling material to a charged polymer gel. Note that the employed light controlling material may be a charging agent.

Examples of the light controlling materials are dyestuffs, pigments, or light-scattering substances. These light controlling materials may be preferably fixed in a charged polymer gel physically or chemically.

Examples of the favorable dyestuffs are black Nigrosine-based dyestuffs; azo dyestuffs displaying various colors such as red, green, blue, cyan, magenta and yellow; anthraquinone-based dyestuffs; indigo-based dyestuffs; phthalocyanine-based dyestuffs, carbonium dyestuffs; quinone-imine dyestuffs; methine dyestuffs; quinoline dyestuffs; nitro dyestuffs; benzoquinone dyestuffs; naphthoquinone dyestuffs; naphthalimide dyestuffs; and perinone dyestuffs. Among them, substances having high index of light absorption are favored. Examples of the favorable substances include C.I. Direct Yellow 1, 8, 11, 12, 24, 26, 27, 28, 33, 39, 44, 50, 58, 85, 86, 87, 88, 89, 157; C.I. Acid Yellow 1, 3, 7, 11, 17, 19, 23, 25, 29, 38, 44, 79, 127, 144, 245; C.I. Basic Yellow 1, 2, 11, 34; C.I. Food Yellow 4; C.I. Reactive Yellow 37; C.I. Solvent Yellow 6, 9, 17, 31, 35, 100, 102, 103, 105; C.I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, 231; C.I. Acid Red 1, 6, 8, 9, 13, 14, 18, 26, 27, 35, 37, 42, 52, 82, 85, 87, 89, 92, 97, 106, 111, 114, 115, 118, 134, 158, 186, 249, 254, 289; C.I. Basic Red 1, 2, 9, 12, 14, 17, 18, 37; C.I. Food Red 14; C.I. Reactive Red 23, 180; C.I. Solvent Red 5, 16, 17, 18, 19, 22, 23, 143, 145, 146, 149, 150, 151, 157, 158; C.I. Direct Blue 1, 2, 6, 15, 22, 25, 41, 71, 76, 78, 86, 87, 90, 98, 163, 165, 199, 202; C.I. Acid Blue 1, 7, 9, 22, 23, 25, 29, 40, 41, 43, 45, 78, 80, 82, 92, 93, 127, 249; C.I. Basic Blue 1, 3, 5, 7, 9, 22, 24, 25, 26, 28, 29; C.I. Food Blue 2; C.I. Solvent Blue 22, 63, 78, 83 to 86, 191, 194, 195, 104; C.I. Direct Black 2, 7, 19, 22, 24, 32, 38, 51, 56, 63, 71, 74, 75, 77, 108, 154, 168, 171; C.I. Acid Black 1, 2, 7, 24, 26, 29, 31, 44, 48, 50, 52, 94; C.I. Basic Black 2, 8; C.I. Food Black 1, 2; C.I. Reactive Black 31; C.I. Food Violet 2; C.I. Solvent Violet 31, 33, 37; C.I. Solvent Green 24, 25; C.I. Solvent Brown 3, and 9. They may be employed singly or in mixed form for obtaining necessary colors.

A so-called reactive dyestuff is preferably employed for stable fixing on a charged polymer gel. It has a polymerizable functional group such as unsaturated double bond in its structure, or other functional groups that can react with a charged polymer gel. The content of dyestuff contained in a charged polymer gel is preferably between 2 and 70 weight %, and most preferably between 5 and 50 weight %. With the content less than 2 weight %, the light controlling action is diminished. With the content more than 70 weight %, it becomes difficult to produce a product of excellent mechanical strength.

Examples of the favorable pigments or light-scattering substances are black pigments such bronze powder, titan black, various species of carbon black (channel black or furnace black); white pigments including metal oxides such as titanium oxide or silica, light-scattering substances such as calcium carbonate or metallic-powders; color pigments such as phthalocyanine based pigments, benzidine-based yellow pigment, Rhodamine-based magenta pigments; and other various pigments and light-scattering substances based on anthraquinone, azo compounds, metal-azo complexes, phthalocyanine, quinacridone, perylene, indigo, isoindolinone, allylamide, and zinc sulfide.

Favorably employed for the yellow pigment are condensed azo compounds, isoindolinone compounds, anthraquinone compounds, metal-azo complexes, methine compounds, and allylamide compounds. In more detail, preferably employed are C.I. Pigment Yellow 12, 13, 14, 15, 17, 62, 74, 83, 93, 94, 95, 109, 110, 111, 128, 129, 147, and 168.

Favorably employed for the magenta pigment are condensed azo compounds, diketo-pyrroropyrrole compounds, anthraquinone, quinacridone compounds, lake compounds of basic dyestuffs, Naphtol compounds, benzimidazolone compounds, thioindigo compounds, and perylene compounds. In more detail, most preferably employed are C.I. Pigment Red 2, 3, 5, 6, 7, 23, 48;2, 48;3, 48;4, 57;1, 81;1, 144, 146, 165, 169, 177, 184, 185, 202, 206, 220, 221, and 254.

Favorably employed for the cyan pigment are copper-phthalocyanine compounds and their derivatives, anthraquinone compounds, and lake compounds of basic dyestuffs. In more detail, most preferably employed are C.I. Pigment Blue 1, 7, 15, 15;1, 15;2, 15;3, 15;4, 60, 62, and 66.

The particle size (of primary particle) for the pigment and light-scattering substance is preferably between 0.001 micrometer and 1 micrometer, and most preferably between 0.01 micrometer and 0.5 micrometer. With the particle size smaller than 0.01 micrometer, they are apt to flow out from a charged polymer gel. With the particle size larger than 0.5 micrometer, they may diminish the coloring characteristics.

The pigments and light-scattering substances are preferably contained in a charged polymer gel in dispersed state as much as possible for the prevention of flow-out from a charged polymer gel. For the purpose, it is preferable to optimize the cross-linking density of a charged polymer gel for the physical closure of pigments or light-scattering substances within the polymer network. It is also preferable to employ pigments or light-scattering substances that exhibit electric, ionic, or physical interaction with a charged polymer get to a large extent or are modified of their surface chemically. Examples of the chemical modification of the surface for pigments and light-scattering substances are introduction of an unsaturated group or a chemically reactive functional group into a charged polymer gel such as vinyl group or a group having unpaired electron (radical), modification of a polymer gel with graft polymerization, and coverage or encapsulation of the surface with polymers.

The content of pigment or light-scattering substance contained in a charged polymer gel is preferably between 2 and 70 weight %. With the content smaller than 2 weight %, the light controlling action is diminished. With the content higher than 70 weight %, it becomes difficult to produce a product of excellent mechanical strength.

Production of such charged polymer gel containing light controlling material is feasible with homogeneous mixing of a non-crosslinked polymer with a light controlling material followed by cross-linking formation, or polymerization of a prepolymer composition added of a light controlling material. In the latter case, it is preferable to employ pigments or light-scattering substances, which contain a polymerizable group or a functional group having unpaired electron (radical) for the facile reaction with a charged polymer gel.

It is preferable to disperse the light controlling material in a charged polymer gel as homogeneously as possible. Especially preferred for the homogeneous dispersion of a light controlling material into a polymer gel is the employment of mechanical blending, agitation, or the utilization of dispersing agent.

As is explained in the above section, it is possible to employ the above-listed light controlling materials as a charging agent contained in a charged polymer gel. Charging of a polymer gel is feasible with the contact charge transfer between a light controlling material contained in a charged polymer gel and a solvent, but provision of charging function to the surface of a light controlling material is more preferable. Such methods include introduction of amino group, ammonium group, halogen group, hydroxyl group, carboxyl group sulfonic acid radical, phosphoric acid radical, amide group, or thiol group on the surface of a light controlling material.

The charged polymer gel preferably has a particle form. It may have various shapes such as spherical, cubic, oval, polyhedral, porous, fabric, star, needle, void, or ring. Among them, a spherical particle is most preferable for the isotropic swelling/compression of the particles of charged polymer gel. The particle size of charged polymer gel is preferably between 0.1 micrometer and 200 micrometer in average without containing a liquid, more preferably between 1 and 100 micrometer. With the particle size smaller than 0.1 micrometer, handling of the particles becomes difficult such as it is impossible to obtain excellent optical characteristics. With the particle size larger than 100 micrometer, various problems are generated including a slow migration rate, etc.

The above particles of charged polymer gel may be manufactured by any of the generally known methods. Examples of them are physical pulverization of charged polymer gel, pulverization of non-crosslinked polymer physically or chemically followed by cross-linking processing yielding polymer gel, and particulate polymerization such as emulsion polymerization, suspension polymerization and dispersion polymerization.

The absorbed amount of liquid for charged polymer gel at swelling is preferably between 2 g/g and 200 g/g. With the amount less than 2 g/g, coagulation between polymer gel particles may be suppressed, or the color purity may be diminished. With the amount larger than 200 g/g, the concentration of light controlling material in a charged polymer gel may be decreased leading to inferior light controlling contrast.

An explanation is given on the liquid employed in the present invention hereinafter.

The volumetric resistivity of the liquid is preferably larger than 10³ Ω, more preferably between 10⁷ Ω and 10¹⁹ Ω, and most preferably between 10¹⁰ Ω and 10¹⁹ Ω. With such figures for the volumetric resistivity, the generation of air bubbles in accompany with the electric decomposition of the liquid due to an electrode reaction may be effectively suppressed. And the deterioration in the light controlling characteristics at repeated energization is avoided, leading to the superior stability for repeated use. In this viewpoint, use of insulating liquid is most preferable in the present invention.

Addition of stabilizers including acid, alkali, salt, dispersion stabilizer, anti-oxidant, UV absorber, anti-bacterial agent, or antiseptic agent to the liquid is allowable as long as the volumetric resistivity remains within the above-specified range.

The preferred embodiments of the liquid include, for example, hexane, cyclohexane, toluene, xylene, decane, hexadecane, kerosene, paraffin, isoparaffin, silicone oil, dichloroethylene, trichloroethylene, perchloroethylene, high purity petroleum, ethylene glycol, alcohols, ethers, esters, dimethylformamide, dimethylacetoamide, dimethylsulfoxide, N-methylpyrrolidone, 2-pyrrolidone, N-methylformamide, acetonitrile, tetrahydrofuran, propylene carbonate, ethylene carbonate, benzine, diisopropyl-naphthalene, olive oil, isopropanol, trichlorotrifluoro-ethane, tetrachloroethane, dibromotetrafluoro-ethane, and mixtures thereof. It is also possible to employ water (highly purified water) as long as the impurities in the water are removed to keep the volumetric resistivity within the above-specified range.

When a liquid and a charged polymer gel (containing a light controlling material) having a difference in the refractive index less than 0.01 are employed for the polymer gel composition according to the present invention, the light-scattering property at the particle interface is diminished and the color purity is improved, both of which are desirable. A combination of such two materials having similarly low refractive indexes favorably facilitates the colored and charged polymer gel particles to suppress the light-scattering phenomenon for the incoming light, allowing easier transmission. Thus such gel particles may be favorably employed for an optical element of transmission type.

The polymer gel composition according to the present invention may expand its application range by solidifying a charged polymer gel and a liquid within a polymer (matrix resin), or by micro capsule formation of them using a polymer film. Such technologies can be implemented as in Japanese Published Unexamined Patent Application No. Hei 11-228850.

There are various methods in the micro capsule formation. They include the so-called coacervation method utilizing insolubilization of a polymeric material, the so-called interfacial polymerization encapsulation in which the polymerization is conducted at the interface of dispersed liquid particles to form a capsule membrane, the in situ micro capsule forming polymerization method, the dry-in-liquid method, the hardening-in-liquid encapsulation method, or the spray-drying encapsulation method in which spraying drops of liquid into a gaseous atmosphere results in the formation of a capsule membrane on the surface. The details of these technologies are discussed in, for example, Tamotsu Kondo, “Micro capsule, Its Production, Property and Application”, revised edition (Sankyo Publishing). The encapsulation may expand the application range of the polymer gel composition according to the present invention by dispersing into other resins, etc.

An explanation is given on an optical element (according to the present invention) that utilizes the polymer gel composition according to the present invention.

The optical element according to the present invention may be employed as it is, when it uses a solidified polymer gel composition according to the present invention, for a light controlling element or a display element. The optical element may be further improved for the better mechanical strength, durability, or functionality utilizing the layered structure of the polymer gel composition according to the present invention formed on a base plate. A sandwiched structure of the polymer gel composition according to the present invention between two base plates is similarly sable.

The optical element according to the present invention needs to be equipped with an electric field applying unit when it is employed for displaying, recording or photo-modulation. But when it is employed as a light shutter or a light sensor responding to imposed electric field, it does not necessitate an electric field applying unit. As a common electric field applying unit, a pair of electrodes may be favorably employed. The patternized or segment-modified electrodes may also be favorably employed for the light control of specified section at will. A charged polymer gel having a specific character corresponding to various patterns is favorably arranged as well.

In the optical element according to the present invention, it is preferable to fix the employed charged polymer gel on an electrode so that it can conduct swelling/compression reversibly based on the interaction with the electrode. When the element has multiple electrodes, this fixation may be carried out on all of them.

The above fixation of the charged polymer gel may be carried out using various bi-functional compounds or adhesives, or using a physical method.

In more detail, it is possible to make a charged polymer gel react with an electrode plate, which has been previously treated with a reactive silane-coupling agent for the introduction of a functional group. The functional group is then reacted with another functional group in the charged polymer gel to make a covalent bond for the secure bonding of the charged polymer gel with the electrode plate. In addition, it is also possible to employ fixing methods using various poly-functional compounds, adhesives, or physical fixing methods based on the three-dimensional processing of an electrode plate for the facile fixation.

In some cases, deterioration of the response characteristics is observed at the fixation of charged polymer gel due to an excessive adherence to the electrode plate. In those cases, it is preferable to fix a charged polymer gel on an electrode (base plate) with a sufficient space between, This can be favorably carried out with processing the surface of a base plate three-dimensionally so that its convex section is reacted with a charged polymer gel. Or the bonding of a base plate with a charged polymer gel may be conducted with a long-chained compound in between.

In the optical element according to the present invention, it is preferable to have a structure in which a light controlling layer, that is the polymer gel composition according to the present invention, is closed airtight. With this structure, the light controlling layer (polymer gel composition) is isolated from the contact of the atmosphere, leading to the better prevention of the deterioration. This may be implemented with the encapsulation of the light controlling layer sandwiched by two electrodes using a resin, or the arrangement of the light controlling layer between two cellar electrodes.

The optical element according to the present invention may allow formation of various effective layers within the element. Examples of the effective layers include a protective layer for the element, an anti-stain layer, a UV absorbing layer, an anti-static layer, a light-reflective layer, a dielectric layer, or a colored layer like color filter.

The following explanation on the optical element according to the present invention is given referring to figures. Functional parts are given of numeral codes throughout the figures, and duplicated explanation is omitted.

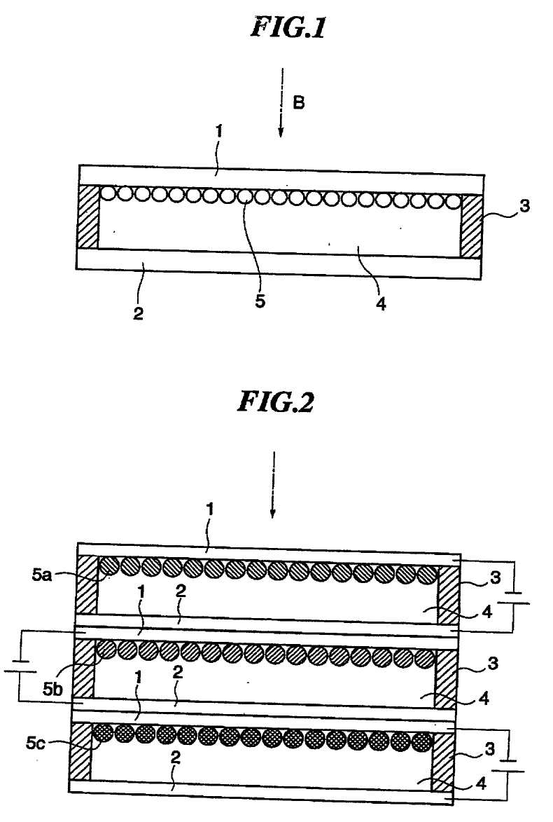

FIG. 1 is a schematic diagram illustrating an embodiment of optical element according to the present invention. It possess a pair of electrodes 1 and 2, at least one of which is transparent, and contains a liquid 4 and particles of a charged polymer gel 5 in a cell made of the electrodes. A spacer 3 is installed between the electrodes to keep a constant distance between them. Meanwhile the charged polymer gel S is fixed on the surface of the electrode 1. The arrow line in the figure denotes the direction of eyesight.

The electrodes (base plates) 1 and 2 are produced generally by forming an energizable member on a plate.

The preferred materials for the plate are polymeric films or plates that are made of polyesters, polyimides, polymethyl methacrylate, polystyrene, polypropylene, polyethylene, polyamides, nylon, polyvinyl chloride, polyvinyliden chloride, polycarbonates, polyether-sulfones, silicone resins, polyacetal resins, fluororesins, cellulose derivatives, polyolefins, and inorganic plates such as glass plates, metal plates and ceramic plates. A base material having the light transmission of at least more than 50% is preferably employed for an optical element of transmission type.

Preferably employed for the energizable member is a layer of metal oxides made of ITO (indium-tin-oxide), tin oxide, or zinc oxide. A transparent electrode having the light transmission of at least more than 50% is preferably employed. Concerning an optical element of reflective type, the energizable member to be formed on the electrode 2, which is located on a distant position from the direction of eyesight, is preferably a layer of metal oxides exemplified by ITO (indium-tin-oxide), tin oxide, or zinc oxide as well as a layer of conductive polymers, a carbon layer, and a metal layer exemplified by copper, aluminum, gold, silver,. nickel, or platinum.

The size and thickness for the electrodes 1 and 2 are not limited in any manner depending on the desired type of optical element (display element), but the thickness is preferably between 10 micrometer and 20 nm. When the electrodes 1 and 2 are both transparent, they may be employed for a display element of transmission type. In FIG. 1 a composition having a pair of electrodes is shown as an example. But a composition having multiple pairs is also allowable as shown in FIG. 2. When the multiple lamination of various species of the charged polymer gel (charged polymer gel 5a, 5b and 5c) is adopted corresponding to different pigments (light controlling materials), the electrodes may be applied to a color-displaying element of laminated type.

It is also allowable to form on the electrodes 1 and 2 a switching element for driving diodes, variable condensers, or dielectric substances that have a composition comprising, wiring, membrane transistor, and a structure of metal-insulating layer-metal. When an image is shown for the display purpose in general, it is materialized with a composition having patternized electrodes, which causes a volumetric change in a charged polymer gel fixed on a pattern carrying out energization at desired patterns. When displaying of a color image is necessary, it may be accomplished by fixing various species of charged polymer gels having different colors on the corresponding patterns, and selective energization at the desired patterns.

### [PREFERRED EMBODIMENTS]

The preferred embodiments of the present invention are described hereinafter with particularity, although the following examples are not intended to restrict the present invention in any manner.

### EXAMPLE 1

Production of Non-ionic Polymer Gel Particles Containing a Charging Agent

Particles of a non-ionic polymer gel that exhibit swelling/compression according to imposed electric field were produced based on the reverse suspension polymerization method as shown below.

Employed were 10 g of N-isopropyl-acrylamide as the main monomer and 0.1 g of methylene-bisacrylamide as a cross-linking agent. Added to the above mixture were 20 g of distilled water, 0.1 g of ammonium persulfate, and 8.0 g of blue pigment (product of DAINIPPON INK AND CHEMICALS, INCORPORATED, micro-capsulated pigment MC Blue 182-E) having a primary particle size of 0.1 micrometer. Agitation of the mixture yielded Solution A. The above procedure was carried out under an atmosphere of nitrogen. Then a solution containing 1.0 g of sorbitol-based surfactant (Product of Dai-ichi Kogyo Seiyaku Col., Ltd., Sorgen 50) in 200 ml of cyclohexane is prepared in a container purged with nitrogen. Solution A was added into the container under vigorous agitation using a high-speed agitation device, yielding an emulsion. Then the reaction system was kept at 20° C. and added of 50% aqueous solution of tetramethylethylene diamine under agitation for the polymerization. After the reaction, a colored polymer gel was obtained. It was separated and washed with purified water.

The colored polymer gel was removed of the contained water by the freeze-drying method. To the colored polymer gel in dried state, added was DMF (dimethylformamide), which had been stored together with molecular sieves after distillation, causing swelling in the particles of colored polymer gel (particles of non-ionic polymer gel).

Preparation of Light Controlling Element

The particles of colored polymer gel prepared in the above section were fixed on an electrode base of 50 mm by 50 mm plated with tin oxide by the following method.

First a solution of silane-coupling agent (3-glycidoxypropyl-trimethoxyl silane) was applied on an electrode surface, heated, and washed yielding a binding layer for fixing the colored polymer gel on the surface.

The above DMF solution of the colored polymer gel was contacted with the treated surface of the electrode followed by heating, causing a chemical reaction between the gel particles and the reactive silane-coupling layer for the secure fixation.

Then an opposite base of 50 mm by 50 mm plated with tin oxide was placed facing the above electrode plate through a resin spacer of 500 micrometer, and the total system was sealed using a thermal adhesive to form a cell leaving an opening for pouring solution. Then only DMF was poured into the cell as the swelling liquid having a volumetric resistivity of about 10⁷ Ω, and the opening was completely sealed to produce a light controlling element (light controlling cell). When the solution of the swelled polymer gel (liquid) was taken out for the measurement of volumetric resistivity, it exhibited a resistivity value originating from DMF.

Evaluation

The light controlling element obtained in the above procedure proved to show a volumetric change in the particles of colored polymer gel according to the application of DC voltage of 35V between the two opposite electrodes. When the electrode fixed with the particles of colored polymer gel was selected as the cathode, the particles of colored polymer gel began to swell. When it was selected as the anode, the particles exhibited compression. Thus the particles of colored polymer gel proved to show swelling/compression property according to imposed electric field. The contrast ratio of the product determined by the refractive index was higher than 30, which also proved superior eyesight confirmation. When the experiment for the polarity reversal by the application of 35V voltage was repeated one million times, it showed that the element was quite stable without observable generation of air bubbles.

### EXAMPLE 2

Production of Ionic Polymer Gel Particles

The particles of ionic polymer gel that show swelling/compression according to imposed electric field were produced in the following manner.

Dissolved into 25 ml of distilled water was 10 g of acrylic acid as the monomer and 0.02 g of methylene-bisacrylamide as a cross-linking agent. Then 6 g of sodium hydroxide was added yielding an aqueous solution of the monomer neutralizing the acrylic acid. It was placed in a flask, evacuated, and purged with nitrogen. On the other hand, 0.2 g of ammonium persulfate as a polymerization initiator was suspended in 200 ml of cyclohexane. This suspension was added to the monomer mixture in a nitrogen-purged container. The system was emulsified by vigorous agitation using a homogenizer. Further, 0.1 ml of tetramethylethylene diamine was added to the system as a polymerization accelerator for the polymerization at 30° C. for 5 hours.

The resulted polymer particles were thrown into a large quantity of distilled water and filtered. The purification of the particles was conducted by repeating the procedure. Finally the particles of ionic polymer gel were obtained.

Preparation of Light Controlling Element

The particles of ionic polymer gel prepared in the above section were fixed on an electrode base of 50 mm by 50 mm plated with tin oxide by the following method.

First a solution of silane-coupling agent (3-glycidoxypropyl-trimethoxyl-silane) was applied on an electrode surface, heated, and washed to yield a binding layer for fixing the ionic polymer gel on the surface.

Preparation of Light Controlling Element

The above dispersion of the ionic polymer gel was contacted with the above electrode glass base followed by heating, causing a chemical reaction between the gel particles and the reactive silane-coupling layer for secure fixation.

Then an opposite base of 50 mm by 50 mm plated with tin oxide was placed facing the above electrode plate through a resin spacer of 500 micrometer, and the total system was sealed using a thermal adhesive to form a cell leaving an opening for pouring solution. Then only DMF was poured into the cell as the swelling liquid having a volumetric resistivity of about 10⁷ Ω, and the opening was completely sealed to produce a light controlling element (light controlling cell). When the solution of the swelled polymer gel (liquid) was taken out for the measurement of volumetric resistivity, it exhibited a resistivity value originating from DMF.

Evaluation

The light controlling element obtained in the above procedure proved to show a volumetric change in the particles of ionic polymer gel according to the application of DC voltage of 35V between the two opposite electrodes. When the electrode fixed with the particles of ionic polymer gel was selected as the cathode, the particles of ionic polymer gel began to swell. When it was selected as the anode, the particles exhibited compression. Thus the swelling/compression property of the particles of ionic polymer gel according to imposed electric field was confirmed. The experiment for the polarity reversal by the application of 35V voltage was repeated one million times. The result exhibited that the element was quite stable without observable generation of air bubbles.

### EXAMPLE 3

Production of Ionic Polymer Gel Particles (Colored Gel of Polyacrylic Acid) Containing a Charging Agent

The production of ionic polymer gel particles that contains carbon black (black pigment or charging agent) was carried out in the following manner.

Added to 50 ml of distilled water was 10 g of carbon black (product of SHOWA CABOT K.K., Showblack: abbreviated as CB hereinafter) having a primary particle size of about 0.1 micrometer and 0.3 g of Emalgen 909 (product of KAO) as a surface-active agent. It was treated on a supersonic dispersing apparatus for homogeneous dispersion of CB, forming a CB-dispersed solution. Then 10 g of acrylic acid as the monomer and 0.02 g of methylene-bisacrylamide as a cross-linking agent were dissolved in 20 ml of distilled water. Then 6 g of sodium hydroxide was added to neutralize the acrylic acid, yielding an aqueous monomer solution. This aqueous solution was mixed with the above CB-dispersed solution in a flask, evacuated, and purged with nitrogen. Added to this monomer mixture was 0.2 g of ammonium persulfate as a polymerization initiator. The resulted mixture was poured into 200 ml of cyclohexane as a dispersing medium, and moved to a container purged with nitrogen followed by vigorous mixing using a homogenizer to give an emulsion. Then 0.1 ml of tetraethylethylene diamine was added as a polymerization accelerator. The polymerization was carried out at 30° C. for 5 hours.

The polymerization yielded black particles of polymer gel. They were thrown into a large quantity of distilled water and filtered out. The process was repeated for the purification. Then the particles were dehydrated using a large quantity of methanol, and dried. The obtained crude particles of the polymer gel were classified to give colored particles of polyacrylic acid gel (black particles of polymer gel) having an averaged particle size of 10 micrometer (in dried state).

Preparation of Light Controlling Element

The above particles of the black polymer gel were fixed on an electrode base of 50 mm by 50 mm plated with tin oxide in the following manner.

First a solution of silane-coupling agent (3-glycidoxypropyl-trimethoxyl silane) was applied on an electrode surface, heated, and washed to yield a binding layer for fixing the colored polymer gel on the surface.

Then a solution was prepared mixing the black particles of polymer gel and DMF. The solution was contacted with the above electrode glass base followed by heating, causing a chemical reaction between the gel particles and the reactive silane-coupling layer for the secure fixation.

Then an opposite base of 50 mm by 50 mm plated with tin oxide was placed facing the above electrode plate through a resin spacer of 500 micrometer, and the total system was sealed using a thermal adhesive to form a cell leaving an opening for pouring solution. Then only DMF was poured into the cell as the swelling liquid (liquid) having a volumetric resistivity of about 10⁷ Ω, and the opening was completely sealed to produce a light controlling element (light controlling cell). When the solution of the swelled polymer gel (liquid) was taken out for the measurement of volumetric resistivity, it exhibited a resistivity value originating from DMF.

Evaluation

The light controlling element obtained in the above procedure proved to show a volumetric change in the particles of ionic polymer gel according to the application of DC voltage of 35 V between the two opposite electrodes. When the electrode fixed with the particles of ionic polymer gel was selected as the cathode, the particles of ionic polymer gel began to swell. When it was selected as the anode, the particles exhibited compression. Thus the swelling/compression property of the particles of ionic polymer gel according to an imposed electric field was confirmed. The contrast ratio of the product determined by the refractive index was higher than 30, which proved superior visual confirmation. Meanwhile, the experiment for the polarity reversal by the application of 35 V voltage was repeated one million times. The result exhibited that the element was quite stable without observable generation of air bubbles.

### COMPARATIVE EXAMPLE 1

Production of Colored Gel of Polyacrylic Acid

The production of pH-responsive polymer gel particles (similar to EXAMPLE 3) that contains carbon black (black pigment or charging agent) was carried out in the following manner.

Added to 50 ml of distilled water was 10 g of carbon black (CB: product of SHOWA CABOT K.K., Showblack) having a primary particle size of about 0.1 micrometer and 0.3 g of Emalgen 909 (product of KAO) as a surface-active agent. It was treated on a supersonic dispersing apparatus for homogeneous dispersion of CB, forming a CB-dispersed solution. Then 10 g of acrylic acid as the monomer and 0.02 g of methylene-bisacrylamide as a cross-linking agent was dissolved in 20 ml of distilled water. Then 6 g of sodium hydroxide were added to neutralize the acrylic acid to yield an aqueous monomer solution. This aqueous solution was mixed with the above CB-dispersed solution in a flask, evacuated, and purged with nitrogen. Added to this monomer mixture was 0.2 g of ammonium persulfate as a polymerization initiator. The resulted mixture was poured into 200 ml of cyclohexane as a dispersing medium, and moved to a container purged with nitrogen followed by vigorous mixing using a homogenizer to give an emulsion. Then 0.1 ml of tetraethylethylene diamine was added as a polymerization accelerator. The polymerization was carried out at 30° C. for 5 hours.

The polymerization yielded black particles of polymer gel. They were thrown into a large quantity of distilled water and filtered out. The process was repeated for the purification. Then the particles were dehydrated using a large quantity of methanol, and dried. The obtained crude particles of the polymer gel were classified to give colored particles of polyacrylic acid gel (black particles of polymer gel) having an averaged particle size of 10 micrometer (in a dried state).

Preparation of Light Controlling Element

The above particles of the black polymer gel were fixed on an electrode base of 100 mm by 100 mm plated with tin oxide in the following manner.

First a solution of silane-coupling agent (3-glycidoxypropyl-trimethoxyl silane) was applied on an electrode surface, heated, and washed to yield a binding layer for fixing the colored polymer gel on the surface.

Then a solution was prepared mixing the black particles of polymer gel and water. The solution was contacted with-the electrode glass base followed by heating, causing a chemical reaction between the gel particles. and the reactive silane-coupling layer for the secure fixation.

Then an opposite base of 100 mm by 100 mm plated with tin oxide was placed facing the above electrode plate with a resin spacer of 50 micrometer dispersed on a surface thereof, a UV-hardening resin was applied on the periphery except for an opening for pouring solution, the base was put together with a base with the gel particles fixed on it, and adhered to each other with UV rays. Then a 0.1N aqueous solution 6fsodium hydroxide was poured into the cell by an evacuation method for the swelling of the polymer gel, and the opening was completely sealed to produce a light controlling element (light controlling cell). Wiring of the cell was carried out with the electrode fixed with the black polymer gel particles as the anode, so that 5 V DC current can be fed from a power source. When the swelling liquid in the cell was taken out for the measurement of volumetric resistivity, it exhibited a resistivity value of 10² Ω.

Evaluation

The black polymer gel particles in the obtained light controlling element before energization were in a swelled state, and absorbed incoming light exhibiting the light transmission of only 2%. After energization, the ionic concentration on the surface of the electrode was altered to show compression of the black polymer gel particles. As the result, the amount of light transmission was increased. But at the same time, generation of a large amount of air bubbles was confirmed. When the energization was stopped, the light transmission was recovered to the original value instantly. After repeated energization of several ten times, the sealed part of the cell indicated a leak due to the generated air bubbles.

As has been described with particularity hereinbefore, the present invention presents a polymer gel composition, which has a simple constitution and can be applied for a display element of transmission type, and an optical clement thereby. The polymer gel composition exhibits large differences in the light-scattering index, light refractive index, and light absorption according to an imposed electric field with stable repeating performance.

The entire disclosure of Japanese Patent Application No. 2001-345865 filed on Nov. 12, 2001 including specification, claims, drawings and abstract is incorporated herein by reference in its entirety.

What is claimed is:

1. A polymer gel composition comprising a liquid and a charged polymer gel that changes its volume by absorbing or releasing the liquid in accordance with an imposed electric field.

2. The polymer gel composition according to claim 1, wherein the liquid comprises an insulating liquid.

3. The polymer gel composition according to claim 1, wherein the liquid possesses a volumetric resistivity of 10³ Ω or higher.

4. The polymer gel composition according to claim 1, wherein the charged polymer gel comprises an ionic polymer gel.

5. The polymer gel composition according to claim 1, wherein the charged polymer gel comprises an ionic polymer gel containing a charging agent.

6. The polymer gel composition according to claim 1, wherein the charged polymer gel comprises a non-ionic polymer gel containing a charging agent.

7. The polymer gel composition according to claim 1, wherein the charged polymer gel comprises a light controlling material.

8. The polymer gel composition according to claim 5, wherein the charging agent comprises a light controlling material.

9. The polymer gel composition according to claim 6, wherein the charging agent comprises a light controlling material.

10. The polymer gel composition according to claim 1, wherein the charged polymer gel has a spherical form.

11. An optical element comprising a polymer gel composition that comprises a liquid and a charged polymer gel that changes its volume by absorbing or releasing the liquid in accordance with an imposed electric field.

12. The optical element according to claim 11, further comprising an electric field applying unit that applies an electric field to the polymer gel composition.

13. The optical element according to claim 11, further comprising an electrode that applies an electric field to the polymer gel composition, wherein the charged polymer gel is fixed on the electrode.
